(19) United States
(12) Patent Application Publication
(10) Pub. No.: US 2013/0081413 A1
(43) Pub. Date: Apr. 4, 2013

(54) METHOD IN TREATING SOLVENT CONTAINING GAS

(71) Applicant: Tomas Åbyhammar, Stockholm (SE)

(72) Inventor: Tomas Åbyhammar, Stockholm (SE)

(21) Appl. No.: 13/702,966

(22) PCT Filed: Jun. 16, 2011
(86) PCT No.: PCT/SE2011/050757

§ 371 Date: Dec. 7, 2012

(30) Foreign Application Priority Data
Jun. 17, 2010 (SE) 1050619-4
Jun. 17, 2010 (SE) 1050620-2

(51) Int. Cl. B01D 53/26; F25B 30/04

(52) U.S. Cl. CPC B01D 53/263; F25B 30/04
USPC 62/112; 95/91

(57) ABSTRACT

A method when extracting solvent and heat from a gas (B) to absorb solvent in a solution (D) containing solvent and one or several absorbents with strong affinity to the solvent, wherein the absorption takes place so that gas (B) and solution (D) is contacted in parallel flow mainly on one side of a heat exchanger, where the heat liberated at the absorption simultaneously is transferred indirectly or regeneratively to a cooling medium (F, G), which meets the absorption media in counter flow.

### FIELD OF INVENTION

The invention is related to methods when treating solvent containing gas in order to extract solvents and heat while using an absorbent with a strong affinity for and with a high solubility in the solvent to be removed from a gas, drying goods or a solution.

### BACKGROUND

In many technical contexts there is a desire to extract solvent and/or heat from a gas. The use of a permanent gas such as air for transport of heat and solvent is a general technical solution. A humid gas can serve as transport medium for solvent and heat in drying processes as well as in other contexts, such as in a solar collector. The latent heat of the vaporized solvent results in a stream of humid gas that is substantially richer in energy compared to a dry gas at the same temperature. In drying processes you want to extract solvent and return heat to the drying goods. There are also many other gas flows which contain much latent heat in the form of heat of evaporation of the solvent, but where the condensation temperature is so low that the use of the heat is difficult or even impossible. Such examples are extraction of heat from waste gases from buildings, combustion or industrial processes.

In extraction of heat and solvents by absorption in a liquid with a strong affinity to the solvent the heat release will take place at a higher temperature compared to direct cooling of the gas. Accordingly, it will be possible to extract heat at a higher and more useful temperature than otherwise. The solvent may also be separated to a higher degree if such a liquid is used. If the solvent is water the liquid with a strong affinity to the solvent is called hygroscopic (a liquid desiccant).

The affinity of the absorbent to the solvent leads to that the vapour pressure of the solvent decreases and thereby the boiling point increases. The increase of the boiling point characterizes the potential of the absorber and the absorption solution. During the absorption the temperature of the liquid increases so that the reduced partial pressure of the solvent above the solution gets closer to the partial pressure of the solvent in the gas. At the point of equilibrium the absorption ceases and the process stops.

Hygroscopic solutions accordingly give a limited reduction of the vapour pressure or a limited increase in temperature. The potential for increase in temperature is usually less than 50 K and the vapour pressure is usually reduced to the level 20-50% of the normal. In traditional techniques one usually work with temperature increases of several hundreds K. The low potential limits the application of hygroscopic technique. There are more powerful desiccants but these are generally difficult to handle and above all difficult to regenerate. They are always more or less corrosive and can also be health hazardous. Examples of such absorbents are strong inorganic acids and burnt lime. Within the hygroscopic technique it is accordingly crucial that the system is designed so that the available potential of the desiccant is used in the best way and so that the desiccant can be chosen as free as possible in order to minimize the inherent drawbacks of most desiccants. If the loss of desiccant has to be minimized because the desiccant is expensive, might harm the product or the personnel, today's systems, in which the whole gas flow is contacted with the absorbent solution, unsuitable. The same applies if the gas contains pollutants disturbing the absorption or the absorption solution, e.g. dust.

The counter-current method is a kind of standard method in absorption processes and is regarded to normally give an effective and well-working plant. However, such systems have not be applied in a broad sense. Designing and running of an industrial plant with counter-current contact might result in great difficulties. One reason is that in this application the ideal liquid flow is small compared to the gas flow being treated, which leads to difficulties in wetting the contact surface without using expensive contact apparatuses, such as plate columns. If the liquid flow is increased by circulation and/or contact in cross flow concentrated and diluted solution will be mixed, which leads to losses in driving power in the system. A further reason might be that hygroscopic substances are carried away with the gas. Purifying the main flow without loosing desiccant ability is both difficult and expensive.

Because of the dilution during the absorption the liquid will loose it's hygroscopic potential. Therefore, the liquid has to be regenerated. This is done by removing the solvent so that the desired concentration of the desiccant is restored. The solvent can be removed from the liquid with any or some of several known techniques, such as boiling in the form of conventional evaporation, evaporation in several steps, flash evaporation, crystallisation by cooling, and also with membrane techniques such as reversed osmosis, molecular sieves and electro dialysis. These methods often give great opportunities to make a process that requires a lot of energy more effective. Especially for thermal methods there are often possibilities to integrate regeneration in other thermal systems by so called cascading.

The gas being treated comprises at least one evaporated solvent but usually also a permanent gas. Other gases may also be present in a smaller amount. The solvent is absorbed under simultaneous heat extraction. Heat is liberated when the solvent transforms into liquid form, is bound to the absorbent and when the liquid is diluted. The liberated heat is comprised of the sum of condensation heat, reaction heat and dilution heat. The gas is contacted with a liquid with a strong affinity to the solvent, so that solvent is absorbed and condensation heat from the solvent is liberated simultaneously with dilution heat of the absorbent.

If the system is closed and permanent gases are evacuated the process can proceed at sub pressure and despite the low pressure produce heat at a temperature above the saturation temperature of the solvent.

The most important characteristic of the absorbent is that within the temperature range in question it shall have a high solubility in the solvent. The absorbent may be a soluble inorganic salt, e.g. of earth metals, foremost the soluble alkaline earth metals Li, Na or K, but also Ca and Mg are common. Very common anions are halides such as chloride and bromide, they result in a good solubility and a great evaporation pressure reduction, but they are very corrosive in technical systems and bromide is unwanted in most environments. Semi-organic salts such as formate and acetate have advantages, such as less corrosivity and less influence on the environment and on humans. Nitrite and nitrate have advantages when used at higher temperatures. In storing, distribution, absorption and concentration of the solution solubility, melting point and thermal dissociation are important limitations. Eutectic mixtures of two or more salts can therefore be of special interest. When using organic absorbents such as mono- or multivalent alcohols the risk of precipitation is avoided but instead there is a risk of great losses at the regeneration, since these compounds have a noticeable partial pressure.

### Waste Gases, Exhaust Air, Etc.

A waste gas created in order to generate heat is upon leaving the heating boiler at the temperature level of 150° C. still very rich in energy, both the moisture and hydrogen content of the fuel form water vapour which binds much energy in the flue gas. Continued heat extraction from the gas is associated with corrosion risks and the water vapour content does not contribute by condensation until a temperature is reached which often underpasses the normal distribution temperature in the heat supply nets. The same often applies for waste gases from industrial ovens and processes. In the industry, recovery is obstructed because heat is normally distributed in the form of vapour at even higher temperatures. Exhaust air from buildings has a less specific content of energy and substantially lower condensation temperature. If it cannot be used momentarily and locally in the building it often stays unused. If the heat in waste gases can be recovered at a raised temperature and further, if the energy from the condensation heat can be added many new possibilities are opened up.

### Heat Treatment of Solid Materials—Drying

In heat treatment of certain materials it is desirable to add heat in order to affect a material in a desired way. A very common form of heat treatment is drying. Then the material to be dried should be heated by adding heat. Gases are separated from the material to be dried during heating, normally in the form of water vapour, which in this context is referred to as solvent. The evaporation demands heat which has to be added. Today this normally takes place by heating air from the surroundings with external energy and thereafter the air is contacted with the material to be dried, whereupon the gas is fed back to the atmosphere together with a large amount of energy, dust, evaporated moisture and other gasified substances. A more powerful heat treatment demands more heat and gives rise to evaporation of more unwanted substances, which makes the open system unsuitable.

### Solar Collectors for Concentration of a Hygroscopic Solution and Production of Heat, Cold and Electricity.

When capturing heat in a solar collector, one always has to calculate with great heat losses from the collector surface back to the surroundings. The losses are often at the same level as the useful amount of heat. Enhancements will therefore have a high impact on the result. By binding captured heat as latent heat of an evaporated solvent the temperature difference relative to the surroundings and the efficiency of the system are enhanced.

Today there are systems wherein a solar collector provides heat to an absorptive cooling machine which produces cold and heat. The disadvantage with these systems is that a high temperature is necessary to drive the absorption process. The reason is that the process as such demands a certain temperature difference, since the temperature is the driving force of the system. Further a temperature drop arises in the transfer and transport of the heat in several different steps in the complex system. A further reason is that the viscosity of working solution is high which leads to that an important temperature difference is demanded in the regenerator in order to create a sufficiently intense boiling, so that an acceptable heat transfer is achieved in the absorptive cooling machine. The heat leaving the process is usually difficult to use because of its low temperature. The efficiency of a conventional solar collector is affected to a substantial degree of the mean temperature in the solar collector, since the losses increase with an increased temperature difference in relation to the surroundings. Increased losses affect the efficiency, partly because of a low effect in operation, but also because the time during which the intended heat can be produced at all is shortened. Demands of high temperature thus lead to a need of increased surfaces or to demands of advanced constructions, i.e. elements which make the systems more expensive. All in all, today's systems have a low efficiency and therefore a limited applicability and in many cases a weak economy.

Solar collectors concentrating a hygroscopic solution are disclosed in U.S. Pat. No. 4,011,731, U.S. Pat. No. 5,182,921 and U.S. Pat. No. 6,513,339. There are also a large number of solutions wherein drinking water and/or a concentrated salt solution are produced from sea water. Common for these systems is that no heat is made useful.

The incident solar energy cannot be controlled, which means that there is a need of simplifying the energy production in time in order to be able to meet future needs. This issue has always been the Achilles' heel of the solar heat. Solar radiation and cooling needs usually have a clear relation, but there is still a need of being able to store cold for shorter or longer times. Storage systems will always have losses of energy and temperature level. In order to give a storage facility sufficient heat effect with reasonable surfaces, dimensions, etc. a certain temperature is needed in order to drive introduction into and removal from the storage facility. Together with what was said above about losses from solar collectors it is clear that temperature level and efficiency always are united quality parameters within the solar heat technology.

### Cooling

A warm but dry gas flow can attain a sufficiently low temperature in order to satisfy normal cooling demands in premises using moistening and evaporative cooling. Many systems of that kind have been described. If the gas is dried in a first step by contacting it with a hygroscopic material this effect is enhanced while at the same time it becomes more predictable.

### THE INVENTION

The object of the present invention is to provide a method of the kind defined in the preamble, which allows an efficient energy recovery and solvent reclamation.

This is obtained with the method according to the invention as it is defined in the characterizing part of claim 1. Developments and preferred embodiments are defined in the sub claims.

The invention thus comprises absorption of solvent from a gas in an absorbent solution with a strong affinity for solvent in such a way that gas and liquid are contacted in parallel flow, mainly in contact with a cooling surface in a heat exchanger, wherein the cooling medium is led in counter flow in view of the absorption media. Since the gas containing the highest amount of solvent is contacted with the most concentrated liquid the theoretically maximum temperature of the system is obtained at the start of the absorption and thereby also in contact with the outlet of the cooling medium. Hereby the theoretically maximum temperature of the useful heat is almost achieved. At the end of the absorption/apparatus the absorption takes place because of the cooling at a lower temperature, so that the absorption continues longer than otherwise, which gives a higher degree of dehumidification and more heat extraction for a given amount added concentrated absorbent. During the absorption the liquid is diluted by the absorbed solvent, which in view of the precipitation risk makes it possible to work with a higher initial concentration of the absorbent and a lower end temperature than otherwise. When the absorption solution is used to a lower concentration the regeneration can be performed with a less driving potential.

The diluted solution can be regenerated/concentrated with several known technologies for concentration of liquids. This can also be done in a way know per se in a solar collector, wherein captured solar energy evaporates the solvent into a circulating stream of gas. Heat and solvent can be extracted by indirect cooling of the gas with a heat carrier. The temperature of the extracted heat however becomes lower than the temperature in the solar collector. With this operation mode, heat, solvent and concentrated solution are produced, all of which can be stored for coming needs.

Instead, by returning the concentrated solution to an absorber/cooler, wherein it is contacted with the gas from the evaporation in the solar collector, the heat will be liberated at a higher temperature compared to the one prevailing in the solar collector. The system thus constitutes a solar collector as well as a solar driven heat pump. The solar collector is moreover more effective compared to other solar collectors, since the losses of heat back to the surroundings are lower. The reason for that is that the captured heat to a large extent exists as latent heat.

If the gas at first is dehumidified and cooled sufficiently far it can thereafter be contacted with the solvent which results in a powerful cooling. The contact takes place in a way corresponding to the dehumidification, i.e. gas and solvent are contacted in parallel flow in a heat exchanger, wherein they indirectly or regeneratively meet the heat emitting medium in counter current. The heat emitting medium is cooled to a level which corresponds well with the demands within the climate field. The heat and solvent taken up this way are fed together with the gas onto the solar collector, wherein further heat and solvent are added in contact with the solar absorber and diluted solution. Thus the amount of heat which reaches the absorber/heat exchanger surprisingly consists not only of the heat captured from the sun but also of the heat taken up from the cooling system. Put together heat is produced with high efficiency at a high temperature level and moreover cold of good quality is produced. Compared to other technologies for producing cold from sun the simplicity of this system is remarkable. Further, the heat from produced cold is delivered at a usually useful temperature level in contradiction to other systems.

### Absorbent

The absorbent is chosen so that a high concentration can be obtained at regeneration and be maintained during storage, distribution and absorption. Precipitation of solid substances as rule gives rise to great difficulties. The absorbent gives the liquid a reduced partial pressure for the solvent, which makes possible absorption at temperatures above the boiling point of the solvent. The absorbent also brings about a lowering of the freezing point of the solvent, which makes operation at temperatures underneath the freezing point of the solvent possible. Put together the invention can be applied within a remarkably wide temperature range.

The absorbent is also chosen in view of the compounds prevalent in the gas in question or which is transferred from the material being treated. By choice of additives to the absorption solution the potential impurities can be absorbed and made useful, and further corrosion and explosive risks can be avoided. Further can be achieved a condition where the process produces a surplus of absorption solution, which can be used in other similar plants or for other purposes.

The principle when choosing absorbent is that the absorbent shall have a strong affinity to the solvent. Even if also other substances than gas or the material being treated come into contact with the solution it is according to the invention advantageous if they can be part of the absorptions solution as an active component. In e.g. treatment of humid wood, organic acids will be liberated together with the water. These will be absorbed in the liquid and give it strongly corrosive properties. If the desired cation, e.g. potassium, is added in the form of an alkaline salt, such as carbonate, the acid can be neutralized and the potassium salt of the organic acid (formate, acetate, etc.) will be the absorbent, which thereby is generated continuously in the process.

Other compounds which condensate under the absorption/cooling but is not dissolved by the absorption liquid will follow the liquid in a two phase flow. These can be organic substances with a low solubility in the absorption solution. The phases are separated with any known method for phase separation. It is also possible to choose working with an absorption liquid consisting of two liquid phases, e.g. water with inorganic polar absorbent and an organic non-polar solvent, wherein organic substances are absorbed. The phases are separated after the absorption and are regenerated each for themselves. Of course, this can also be performed in two distinct absorption units with separate absorbents.

If the gas contains both ammonia and water such as for example in treatment of manure or municipal sewage water can be the absorbent for an otherwise similar process. The condensate from the regeneration can be treated with distillation so that a water solution of ammonia with commercial concentration is formed at the same time as the rest of the water is relieved from ammonia.

It is also possible to choose a hygroscopic absorbent for the water, which in turn is absorbent for ammonia in a common absorption. By addition to the absorption solution of e.g. nitric acid in order to balance the acidity of the solution, ammonia is efficiently bound in the growing absorption solution and water can be removed through evaporation. Ammonium nitrate will then be formed and be a powerful absorbent. The net production of absorbent can be used for other purposes, e.g. for plant nutrition. When using the nitrate explosion risks have to be accounted for in the same way as is known within the fertilizer industry.

If the gas is comprised of a flue gas containing water, ammonia and nitrogen oxides the absorbent can be completely or partly in the form of ammonium nitrite and ammonium nitrate. If the component which prevails in deficit is added to the solution the absorption of other compounds will be stimulated because nitrite and nitrate have a low partial pressure. Thereby the method can be used as a cleaning method for ammonia and nitrogen oxides, which normally is a very urgent measure in view of flue gases. The water becomes the component which is evaporated at the regeneration and the surplus of the growing solution can be used for other purposes.

If the gas consists of a flue gas containing water and a lot of different inorganic compounds (e.g. ashes) those substances may be allowed to remain in the solution to be part of the absorbent, while those forming a solid phase are separated from the solution with some known method. Everything that dissolves in the liquid adds to the desired boiling point increase and is thereby desirable in principle.

If the gas contains the desired cations Na, K they will be enriched in the solution. At absorption in flue gases the carbonates will normally be formed from the carbon dioxide in the flue gas and these will form part of the absorbent. An alternative to adding the other component in the absorbent from an external source is to let the absorption solution alternate between two different systems, which each add one of the desired components. One example of such a composite system is a combustion plant for wood fuel wherein the drying agent alternates between a fuel dryer, wherein organic acids are liberated and a flue gas dryer, wherein the ashes in the gas contains large amounts of alkaline metal ions, mainly potassium. The absorption liquid will initially contain much potassium carbonate from the ash. Potassium carbonate is an absorbent with medium properties. After a certain time of operation and after separation of insoluble substance the solution will be enriched in potassium acetate and potassium formate, which both are very efficient absorbents. In order to limit the corrosive properties of the solution halides should be removed, especially chloride from the solution, using some known method. The surplus produced by the system can be exported for another use, e.g. as anti-freeze agent or as plant fertilizer. A bleed from the system is also advantageous for preventing build-up of unwanted substances, which are not separated in another way.

### Prior Art Related to the Invention

When absorption of a solvent from a gas is performed with the aid of a hygroscopic material this is usually a solid material such as a mineral salt which is anchored on a support surface. General applications are drying of pressurized air in solid porous dryer beds or dehumidification of ventilation air in buildings with rotating hygroscopic heat exchanger wheels.

It also occurs that liquid drying agents are used. This results in advantages at regeneration, storage and transport of the drying agent. The liquid form also means limitations and difficulties, e.g. in the form of precipitation, corrosion, carry-over, evaporation and loss of drying agent.

### Flow Conditions

Absorption of water vapour in pressurized air is the most applied form of artificial drying and is performed on a daily basis, usually in a stationary porous bed with a solid drying agent.

Absorption of water vapour with hygroscopic solutions from humid air in a drying system at atmospheric pressure is also previously known. Absorption with a hygroscopic liquid gives more possibilities to arrange the absorption process, e.g. contact in parallel flow, counter flow or cross flow. The second most applied for of artificial drying is drying of natural gas in order to avoid corrosion in the distribution systems. In this concept, extraction of heat is not the aim, but instead a very far-reaching dehumidification. At drying of natural gas multivalent alcohols are used e.g. as liquid drying agents.

In absorption with liquids, absorption in counter flow has been applied in most cases, since this is regarded as being the best method according the teaching of chemical engineering science, see e.g. SE 423,488 and U.S. Pat. No. 4,290,208. In drying of natural gas, distillation columns of plate type are use, which is a very expensive contact apparatus. In other cases cross flow is used, since this is a practical method when a too small liquid flow has to be circulated in the absorption apparatus in order to keep the surfaces wet. Mixed flow or parallel flow/cross flow is applied for absorption without permanent gas, e.g. in closed systems such as in chemical heat pumps, se e.g. JP 02146475. Absorption in parallel flow is generally regarded as an inferior method compared to the other contact means, and therefore it is surprising that contact in parallel flow in several ways gives a remarkably good result, when it is applied according to the invention.

### Heat Transport

The heat liberated from an adiabatic absorption results in an increased temperature of the absorbing media. The heat leaves the process with both media and mainly with the medium having the largest product of mass flow and heat capacitivity. If the main object is to dehumidify a drying gas, the dehumidified reheated gas is used directly with heat exchange. Then it is obvious to apply a non-cooled, adiabatic absorption process in counter flow, see e.g. SE 423,488. If the object is to extract heat externally the absorption is performed adiabatically, whereupon the solution is heat exchanged outside the absorption apparatus without contact with the absorption process, see e.g. U.S. Pat. No. 3,894,528. According to the invention the absorption and the heat extraction take place simultaneously and in a way that optimizes the dehumidification and the temperature level of the extracted heat.

### Temperature Conditions

The sensible heat above the dew point of a humid gas contains as a rule only a small amount of energy which moreover is difficult to heat exchange without a great loss in temperature, corrosion problems, etc. At condensation without hygroscopic liquid the highest useful temperature is limited to a level close to the dew point of the gas. At absorption with a hygroscopic liquid a higher temperature can be reached, i.e. the equilibrium temperature of the extracted heat, which depends on the boiling point increase of the liquid at the concentration in question and on the concentration of the solvent in the gas. Further, the corrosive effect of substances in the gas is mitigated through dilution and neutralisation. Prior art for heat extraction from corrosive waste gas is disclosed in SE 8001144-8. At absorption with hygroscopic liquid in counter flow it is possible to reach a temperature close to the equilibrium temperature for the concentrated solution and the least concentrated gas, which is always lower than at contact according to the invention. In application of the invention, the temperature of the extracted heat increases compared to the prior art, which increases the field of application for the heat. A common case is when the aim is to return the heat to the process which has generated the humid gas, for example a drying process. In such a case even a small temperature increase is of great value. In other cases new fields of application are opened with increasing temperature.

### Regeneration

The regeneration of the liquid is facilitated if a larger part of the solvent can be removed at a lower concentration, which reduces the demand of potential (temperature or pressure) for driving of the separation. Further the flow of absorbent is reduced if the solution is utilized to a lower concentration in the absorption.

### Influence of Another Substance—Emissions

Earlier application in drying of wood with hygroscopic solution has resulted in a strongly corrosive absorption solution. The pure absorption solution was not corrosive, but after the absorption of organic acid a strong corrosivity evolves. According to the invention also other substances than the solvent are absorbed in a controlled fashion in order to avoid emissions, corrosion or other inconveniences and in order to make use of the substance or its content of energy. Previously these aspects have not been considered.

### Internal Production of Absorbent

According to the invention other substances are absorbed in a controlled fashion also for making use of the substance for the production of drying agent and/or other products. These aspects were not considered earlier.

### Heat Treatment of Solid Substances—Emissions, Exhaust of Environmentally Disturbing Substances

With the technology which is mainly applied today (drying with air from the surropundings passing through) large discharges of energy, dust and volatile compounds from the drying goods take place together with the very substantial flow of air passing through. A method according to the invention results in a process which is substantially closed towards the atmosphere with negligible discharges to the atmosphere and with small discharges to the water systems of the surroundings. This is also valid if the heat treatment is driven further than in normal drying, e.g. to torrefaction or carbonization of wooden materials. Here the value of low emissions and the product value of extracted material are even bigger.

### Solar Collectors

Solar collectors, wherein the thermal efficiency is improved by transfer of captured heat to latent energy in a solvent, which is evaporated, is disclosed in U.S. Pat. No. 3,894,528 and U.S. Pat. No. 6,513,339. According to the invention the heat is delivered at a higher temperature than in the application according to the prior art. The invention can also be applied so that cooled gas is added between cover glass and absorber, which further increases the efficiency.

The solar collector according to U.S. Pat. No. 3,894,528 can not be directed towards the sun, since it based on a basically horizontal principle. According to the invention the solar collector can be inclined at an optimum angle in order to follow the height of the sun as well as the day-to-day rotation of the earth.

The solar collector according to the invention can be used in order to produce a concentrated solution, solvent and heat of ordinary temperature, which can be stored for coming needs. It can also produce cold for most of the existing cooling needs and heat at a substantially higher temperature and efficiency, compared to other planar solar collectors.

Other solar collectors producing heat at a high temperature have a complicated structure with reflectors, glass tubing, etc., which besides a high cost also can be difficult to attach to a building. According to the invention, the solar collector can advantageously be designed as a planar solar collector, which gives advantages in the use of available surfaces.

A number of systems have been described and realized where a solar collector generates heat, which drives a thermo chemical process (cooling machine, heat pump or heat transformer), which produces useful cooling but heat at a non-useful temperature level. These systems are dependent on a high driving temperature, partly because the temperature is the driving potential in the system but also since thermo chemical processes comprise liquids with a high viscosity needing a big temperature difference in order to create an acceptable heat transfer in a number of heat exchanger steps. This leads to that advanced and expensive solar collector structures are needed or otherwise a low efficiency is accepted and a low level of utilization, which lead to a great need of surface and space. According to the invention the critical thermo chemical process takes place in connection with the absorber of the solar collector without transfer of heat in several steps.

### OTHER ADVANTAGES OBTAINED WITH THE INVENTION

### The Extracted Solvent

The solvent obtained gets qualities not given by other processes since it passes through different stages wherein chemical, physical and biological properties are affected. The solvent is after the absorption dissolved in a solution with a strongly deviating osmotic pressure, which can be expected to dry out and kill living cells and other biologically active material such as allergens and infectious agents. The fact that regeneration by boiling can result in disinfection through heating and explosion is obvious, but during the vapour formation there is also a separation of substances, compounds and particles having low vapour pressure, so that the separated solvent gets properties which open up new ranges of application. If the solvent is water, the distillate can hereby obtain qualities which are unexpected in view of the origin of the water. The distillate can e.g. be suitable as drinking water, washing water or for humidification of dried air being led to sensitive premises even if its origin is for example sewage sludge.

### The Gas

It is previously known that a gas being contacted with a strongly hygroscopic liquid experience strong physical action which might be positive e.g. when humid environments otherwise are exposed to proliferation of micro organisms, etc. Air being contacted with a salt is in some contexts regarded as giving positive health effects among other things by counteracting allergic reactions from pollen, etc. Ventilating air having been treated in this way can thereby obtain a number of added properties in addition to the distinct physical conditional changes. In drying plants formation of mould is often a problem which can be attenuated by the contact with absorption solution or an aerosol thereof.

### DETAILED SPECIFICATION

The invention will now be described more in detail with reference to embodiments of the invention. The solvent is absorbed in a solution which consists of an absorbent with strong affinity to the solvent and with a great solubility therein. If the solvent is water such substances are called hygroscopic. Known hygroscopic substances are mineral salts, carbonates, alcohols, glycols and salts or organic acids such as formate and acetate. Salts of lithium, sodium, potassium and calcium are used frequently, since they have a good solubility and strong affinity to water. Even if in the following specification for the sake of simplicity water and hygroscopic substance are discussed, the invention comprises accordingly other conceivable combinations of said kind.

### Applications

### Extraction of Heat From Solvent Containing Gases

Extraction of solvent and heat at a raised temperature from a gas stream passing through, such as exhaust gases, used air, outside air, inlet air, etc. through absorption from the total gas flow so that gas and absorption solution is contacted in parallel flow while at the same time heat exchange (cooling) takes place in counter current in view of the absorption media.

Production of heat at raised temperature from humid flue gas by contacting the flue gas from a combustion plant with absorption solution in the inlet of a heat exchanger, wherein the gas and the solution are cooled in counter flow by a heat carrier, which takes up heat at a temperature exceeding the dew point of the gas. If the gas has a high dust content it should be purified from dust before the absorption. During the absorption further particles will be separated from the gas, which particles can be separated from the solution with any suitable, previously known method for particle separation. There is no need for retreating of the gas as it is already dry.

### Treatment of Solid Material—Drying

Here is contemplated a process, in which a material is heat treated so that solvent vapour departs from the material. Many drying goods, e.g. material of biological origin, are affected in several ways when heated. Already when water is evaporated at low temperature from e.g. a wooden material e.g. a considerable amount of hydrocarbons (mainly terpenes) is liberated. At raised temperature decomposition of the wood substance will occur, which among other things leads to that several different gaseous compounds and water vapour as well as liquid are liberated. The origin of the liberated water vapour can thus be partly initial moisture in the material and partly be of a decomposition product from the biological substance.

In heat treatment of lignocellulose containing materials such as wood one is talking about torrefaction as a mild heat treatment at temperatures of up to about 250° C. and carbonisation as a more intense action with a higher end temperature. During these processes are liberated, in gaseous form, water vapour and carbon dioxide, combustible gas, mainly carbon monoxide, and to some extent hydrogen gas, simple hydrocarbons such as methane, ethane, ethylene and ethyne, and organic acids. Heavier hydrocarbons such as waxes, resins and asphaltic terpenes are liberated both in gas and liquid form. Exhausting these substances to the surroundings is unwanted, on the one hand because they pollute the environment, on the other hand because they can represent a certain value. Unexpected effects are that even water from the decomposition of the drying goods adds to the energy balance of the system when it is absorbed and in that the acids which are liberated in larger amounts at the decomposition also can be made useful. Further the liberated combustible gas can be used as fuel in order to drive the system and also make possible the production of some electric power.

In drying of a solid material with the aid of a circulating gas the object of the process is to extract solvent and to return liberated heat to the circulating gas, which is performed by contacting part of a circulating gas flow with absorption solution in parallel flow, while at the same time heat exchange is performed in counter flow in view of the absorption media flow. The gas which is led to absorption can be taken out from the main flow before or after the heat exchanger. The dry cooled gas, which is led from the absorption is returned to the main gas stream. This can take place before or after the heat exchanger for the main flow, but it can also be led via the goods for which the drying is finished, so that heat can be recovered from the goods before it leaves the process.

a. The heat extracted in this way is transferred to the circulating main flow of gas in order to restore the drying ability of the gas before it is again contacted with the drying goods, see FIG. 1.

b. The extracted heat is transferred directly to the drying goods through heat exchange, so that the evaporation procedure can continue and solvent be transferred to the circulating gas, the flow of which can be reduced considerably compared to the previous solution, see FIG. 2.

In both cases the capacity is increased by increasing the pressure of the gas before the absorption with the aid of a compressor. This is suitable only if the dew point of the gas lies close to the boiling point of the solvent, so that pressure losses in the permanent gas remaining after the absorption are minimized, see FIGS. 3 and 4.

### Solar Collector

1. Extraction of solvent and heat from a circulating gas flow by cooling and absorption from the total gas flow, for example heat extraction from a solar collector, wherein the heat losses are reduced by taking up and transporting the latent heat in a solvent, which is evaporated in the solar energy absorber of the solar collector.

1a. Concentration of a hygroscopic liquid by circulating a gas flow in a solar collector, wherein solvent is evaporated with heat from the sun, so that the absorption solution is concentrated while at the same time heat and solvent are extracted in a cooler placed in the circulating gas stream. Heat, solvent and solution can be stored according to prior art technology in order to meet future needs.

1b. Concentration of an absorption solution with a circulating gas flow in a solar collector according to 1a, wherein a heat pump function is achieved by contacting a humid gas in parallel flow with the concentrated absorption solution at the same time as a heat carrier is heat exchanged in counter flow in view of the absorption media.

1c. Production of cold. A humid air stream circulating in a solar collector according to 1a and 1b is contacted in parallel flow with a hygroscopic solution under heat exchange (cooling) in counter flow so that the gas becomes cool and dry. The gas is humidified with solvent (normally water, e.g. extracted from the hygroscopic solution) in parallel, counter or cross flow so that the gas and solvent flow is cooled. Produced cold can be distributed with the gas and/or solvent and/or be heat exchanged to another cold carrier in counter flow to the gas.

### SHORT DESCRIPTION OF THE DRAWINGS

The invention will be described more in detail with the purpose of illustration and in order to facilitate the understanding of the invention with reference to embodiments shown on the accompanying drawings in the form of a drying process and a process for using solar energy.

In the drawings,

FIG. 1 shows a schematic flow chart for extraction of solvent and heat from a gas,

FIG. 2 shows a schematic flow chart for extraction of moisture and recovery of heat from a circulating gas flow in a drying process,

FIG. 3 schematically shows a drying apparatus with an internal heat exchanger surrounded by drying goods, wherein the absorption takes place in the heat exchanger and heat is directly transferred to the drying goods,

FIG. 4 shows a schematic flow chart for extraction of moisture and recovery of heat from a circulating gas flow in a drying process combined with a compressor, which gives a combined chemical and mechanical heat pump function,

FIG. 5 shows schematically a drying apparatus with internal heat exchanger surrounded by drying goods, wherein the absorption takes place in the heat exchanger and heat is transferred directly to the drying goods in combination with a compressor, giving a combined chemical and mechanical heat pump function, and

FIG. 6 shows a schematic flow chart for extraction of moisture and recovery of heat from a circulating gas flow in a drying process wherein the energy recovery takes place with a chemical and mechanical heat pump, and

FIG. 7 shows schematically a first embodiment of a device for the production of heat, hygroscopic solution and a distillate with the method according to the present invention,

FIG. 8 shows a view corresponding to FIG. 7 of another embodiment of the device for performing the method according to the invention, wherein the absorber is gas permeable,

FIG. 9 shows still another embodiment of a device for performing the method according to the present invention, wherein the production of heat at a higher temperature to an optional degree could be given priority at the expense of other utilities, wherein the device comprises an internal absorption heat pump,

FIG. 10 shows schematically an alternative embodiment of the device for performing of the method according to the invention, wherein the absorber is comprised of panels of solar cells for simultaneous production of electricity,

FIG. 11 shows a solar collector for the production of heat, cold, concentrated solution and distillate with heat exchanger and storage integrated in the solar collector or separately there from, and

FIG. 12 corresponds to FIG. 11 with inserted operational data at an incident radiation corresponding to 0.73 kW and a circulation flow of permanent gas of 7.2 grams/second.

### EMBODIMENTS

### 1. Drying Process

The solvent is absorbed in a solution consisting of an absorbent with a strong affinity to the solvent and good solubility in the same. If the solvent is water such substances are called hygroscopic. Known hygroscopic substances are mineral salts, alcohols, glycols, and salts or organic acids, such as formate and acetate. Salts of lithium sodium, potassium, calcium and magnesium are frequently used, since they have a good solubility and strong affinity to water. Even if for the sake of simplicity water and hygroscopic substances are discussed in the following description, the invention thus comprises all other possible combinations of said kind.

When humid exhaust gas is contacted with the absorption solution in the inlet of a heat exchanger of a suitable kind, the absorption is started with vapour and the temperature of the two media rise to a level close to the equilibrium temperature. When the media come into contact with the cooling surfaces of the heat exchanger heat is efficiently transferred to the cooling medium, e.g. a heat carrier liquid. The absorption proceeds as the temperature sinks. The gas becomes more and more dry and the absorption demands continued cooling in order to proceed. The inlet temperature of the cooling medium is thus an important parameter, which decides how far the absorption will run. The specific heat transfer in this part is good, since the vapour condensates in the liquid, which is in intimate contact with the surface transferring heat. The process is advantageously performed in the tubes of a standing tube heat exchanger, wherein the absorption solution forms a so called falling film which gives good conditions for absorption and heat transfer. If large amounts of gas shall be treated with the absorption or if the heat shall be transferred to a large gas flow, other types of heat exchangers can be contemplated, for example so called rotating (regenerative) heat exchangers.

As already mentioned in the preamble, in systems of today the total gas flow is treated by dehumidification and simultaneous reheating in an adiabatic process (latent heat in the vapour is transferred into sensible heat in the gas). The specific heat demand for overheating e.g. air is about 1 kJ/kg.K. At 50 K superheating 50 kJ/kg air is thus needed. Vapour formation heat in steam is about 2200 kJ/kg, which means that about 0.023 kg steam needs to be absorbed for each kg gas to be heated. If the steam content of the gas is substantially larger than 0.023 kg/kg it can be noted that only a smaller amount of the gas is required for the absorption under the condition that the large part of the steam is absorbed in the smaller flow. At working temperatures close to the boiling point of the solvent it is thus sufficient to absorb from 5 to 10% of the total flow. (Saturated air at about 28° C. contains 0.023 kg/kg, which indicates that the whole gas flow has to be used for the absorption, but since the overheating cannot reach more than about 25 K at this temperature level about 50% of the gas flow is needed.) The share of the gas needed at the absorption thus depends on partly the working temperature and partly on the absorbent. If the gas only consists of steam or if humid air is used in a system that is heated towards the boiling point of water, so that the gas will be dominated by steam, the above condition will be accentuated. The specific heat of the steam is about 2 kJ/kg.K, which means that the share of the gas flow that has to take part in the absorption increases with a few % to: 50×2/2200=0.045 kg/kg. Since the share of steam in the gas is high the share of gas that has to be treated decreases.

According to the invention the process is divided into two steps, one absorption step, wherein vapour is absorbed in the hygroscopic liquid while at the same time heat is liberated in the liquid; and a second step for transfer of heat from the liquid to the gas.

The first step is working with concentrated media and demands a small contact surface and a relatively small driving power. The second step, which involves transfer of heat to a permanent gas, however, demands a large contact surface or a large driving power. As has been mentioned above the driving power at dehumidification with hygroscopic liquids is very limited, which is why substantial contact surfaces are needed in order to realize the process. In today's methods a large contact surface thus has to be wetted with a hygroscopic liquid.

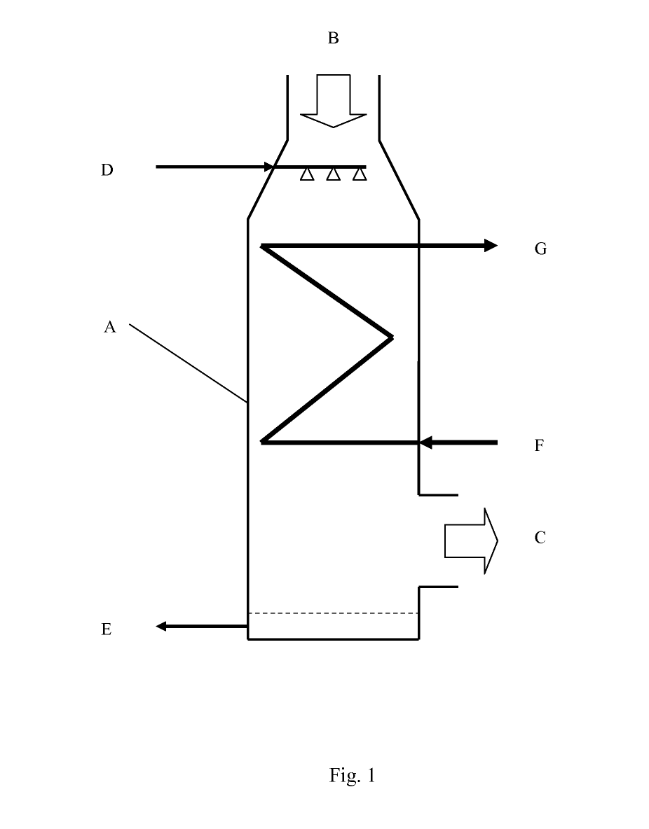

The principles of the invention are evident from FIG. 1. The gas B is contacted with a concentrated absorption solution D in the inlet to the contact apparatus A. The liquid absorbs solvent resulting in that the temperature of both media rises. The absorption media reach the cooling surface F-G where the heat carrier F-G takes up heat from the absorption. The dried gas leaves the apparatus at C, the diluted solution at E and the heated medium at G.

### Heat Treatment of a Solid Material

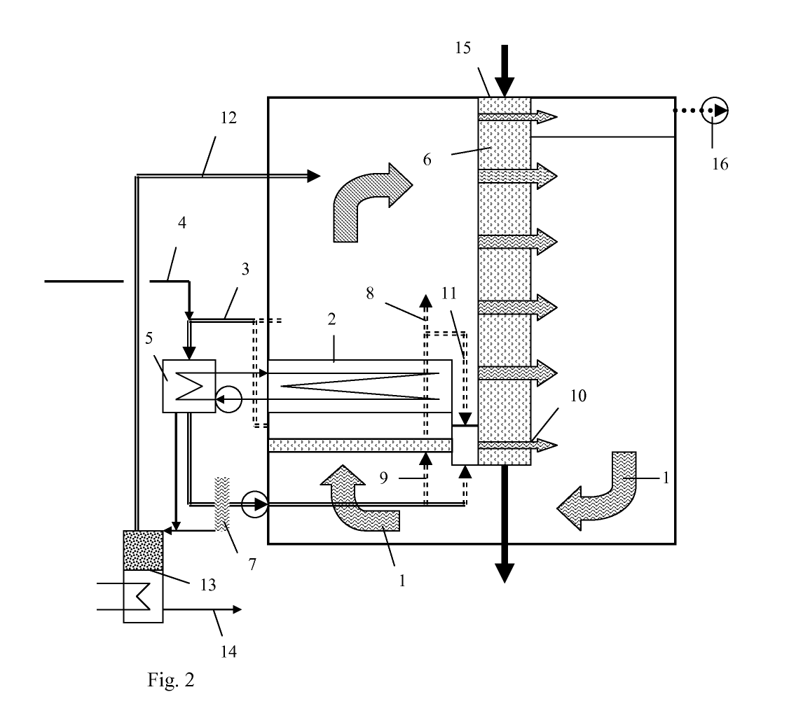

The invention is based upon that the two processes are separated physically so that the humid gas flow 1 is heated in a large but dry heat exchanger 2 of a conventional design as is shown in FIG. 2. A partial stream 3 (5-50% of the main flow) is taken out before or after the heater. The smaller stream is contacted with the absorption solution 4 in parallel flow in a smaller heat exchanger 5, wherein the surfaces are wetted by the solution. Already at the initial contact with the solution, gas and solution are heated to a temperature close to the equilibrium value in question for the dehumidification. Gas and liquid then pass in the same flow direction through the heat exchanger. The heat is transferred to the large heat exchanger which heats the main flow 1.

Thermally the heat exchangers are coupled in counter flow, which means that the positive effect of counter flow surprisingly is achieved despite that gas and liquid are contacted in parallel flow. The limiting parameter for the drying capacity of the air is the temperature rise that can be achieved for the large stream of gas before it is led to the drying chamber 6. Highest temperature is achieved when the most concentrated solution is contacted with the gas having the highest water content. Thus, somewhat surprisingly, a higher absorption temperature is achieved in this split process, in which the absorption takes place in parallel flow, in comparison with the previously know combined counter flow process. The cooling in connection with the absorption results in that the absorption process can absorb more moisture and deliver more heat at given flows compared to an adiabatic process.

The absorption process is thus, contrary to the prior art, performed only in a smaller partial stream of the main flow, It is performed in parallel flow and further it is cooled (i.e. not adiabatic). In order to remove traces of the absorption solution in the product the smaller part flow from the absorption can if necessary be purified, as is indicated at 7, also with methods involving a high specific cost, or wet methods which remove the drying capability of the gas. There is also the possibility to discharge the smaller gas flow after the absorption. Such measures are impossible or very expensive in the prior art processes.

If the dehumidified flow is re-humidified in a purification step it should thereafter be treated according to point 2 below. If the gas is not humidified it can be used in any of the ways discussed below:

The gas is returned to the main flow before the heater, arrow 8, wherein the drying capability of the gas can be used.

The gas is returned to the main flow before the heater, arrow 9, wherein the drying capability is enhanced further through the heating.

The gas is led through the drying goods, for which the treatment is finished, arrow 10, at which the dry gas regains heat through cooling (and drying) of the drying goods.

The gas is first led through the heater and then through a cooling zone in the drying goods in order to obtain a more powerful drying and simultaneous cooling of the drying goods, arrow 11.

If one wishes a certain sub-pressure in the apparatus, part of the gas can be led away from the process, which is not shown in the Fig. Since the gas is relatively poor in energy it is suitable to choose this gas for this purpose. An alternative way of extracting a gas is discussed below.

The working temperature of the process is about the same as the wet temperature of the drying goods. This temperature also controls the composition of the gas. In order to obtain the intended working temperature for the process, gaseous solvent (steam), arrow 12, is added to the circulation gas flow. The steam condensates in the cold drying goods while at the same time heat is transferred to the goods. The temperature of the goods controls the composition of the circulating gas in that at rising temperature an increasing share of steam displaces other gas (air). High temperature will thus give a high share of solvent (steam) and a low share of oxygen in the gas, which counteracts fire and explosion. The working temperature is controlled through a controlled addition of steam. Added steam can also be used in order to give the material the desired temperature and moisture profiles, e.g. as a post treatment of the dried product. If the added steam is contacted with the solution from the process the volatile substances can be returned to the process together with the steam in the way shown in FIG. 1 by heat supply and evaporation 13. Steam and impurities are added to the warm gas, arrow 12, and purified concentrated solution is drawn off, arrow 14.

The working temperature can be changed during the process, e.g. when treating heat sensitive materials, through increased or decreased steam supply. If the solvent is not combustible an embodiment where the working temperature is close to the boiling point of the solvent, is preferred, so that the composition of the gas counteracts fire and explosion. This ambition has to be balanced against the high temperature durability of the drying goods.

The humid gas that passes through the cold drying goods at the goods inlet 15 at continuous feeding of the goods or initially when working in a cyclic fashion, will loose moisture and energy through condensation, and the material will be heated and humidified. The remaining gas will thus be depleted of moisture and energy and mainly contains permanent gas (air) and other substances that the drying goods possibly has emitted and which in contact with the absorption solution is more volatile than the solvent. Especially those substances that have low affinity to the absorption solution, e.g. carbon monoxide and other hydrophobic substances such as hydrocarbons are enriched in this flow. From this flow a certain share is evacuated from the process, arrow 16, suitably so that the content of combustible substances in the system is limited to a non-combustible level. At the same time a sub-pressure is created in the system which counteracts leakage to the surroundings from the possible leakage points of the system. The evacuated gas can be treated e.g. by combustion in order to avoid influence on the environment and in order to use the energy content of the gas. The amount of evacuation is governed partly by the sub pressure in the system and partly by the content of combustible substances in the gas, so that fire and explosion are avoided.

The heat exchanger system used can consist of two separate regenerative heat exchangers 2, 5 with a heat transferring liquid between the heat exchangers, as is shown in FIG. 2, but also other heat exchanger systems can be used. The system can also be devised with a heat exchanger so that the absorption can be performed on one side of the heat exchanger and gas or goods can be heated on the other. Periodically working so called recuperative heat exchangers can be used where a (smaller) part of the heat exchanger is contacted with the absorption process, which heats the heat exchanger material which thereafter is brought into contact with the main flow of gas, which takes up said amount of heat. Such exchangers can be designed as two or several separate units working periodically. Another commonly prevailing design is rotating wheels with separate sectors for the different medium flows. A less common design which can be used is a stationary unit of heat surface which has been designed so that the medium flows are periodically redirected in the desired way.

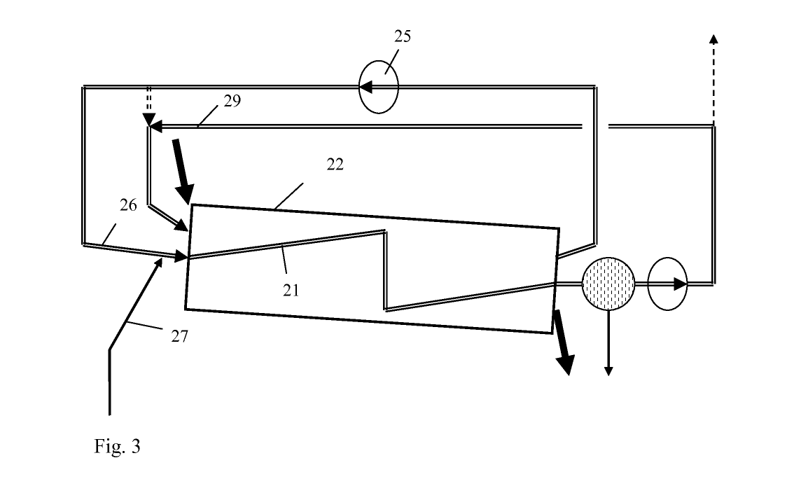

Another embodiment of the invention is shown in FIG. 3. Hear the heat exchanger is placed so that it is encased by the drying goods. Several apparatus structures with built-in heat exchangers for traditional heating media are previously known. According to the invention the absorption is performed, in this case, on one side of the heating surface and on the other side the heat is directly transferred to the drying goods. This is evident from FIG. 3, wherein a heat exchanger 21 is arranged in a drying apparatus 22. Drying goods, arrow 23, is led into the contact apparatus at one end and dried goods, arrow 24, is taken out of the contact apparatus at a second end. Humid carrier gas is circulated from the second end with the aid of a blower 25 or corresponding means to the inlet end of the heat exchanger 21, arrow 26, whereto also is added concentrated absorption solution, arrow 27. Carrier gas from the heat exchanger is circulated with the aid of a blower 28 or corresponding means, after separation of a diluted solution, to the inlet for drying goods in the contact apparatus, arrow 29, possibly together with part of the other circulating carrier gas flow (26).

Such a design has advantages in the form of lower demand of gas flow and apparatus volumes but also disadvantages in the form of a greater dependence on the properties of the drying goods. It is of course also possible to use a heat carrier to transport heat from an absorption means according to FIG. 2 and a heat exchanger according to FIG. 3. At this design the thermal coupling in counter flow is not as important as in the earlier described case. As is evident from FIG. 3 it is also affected by the design of the contact apparatus.

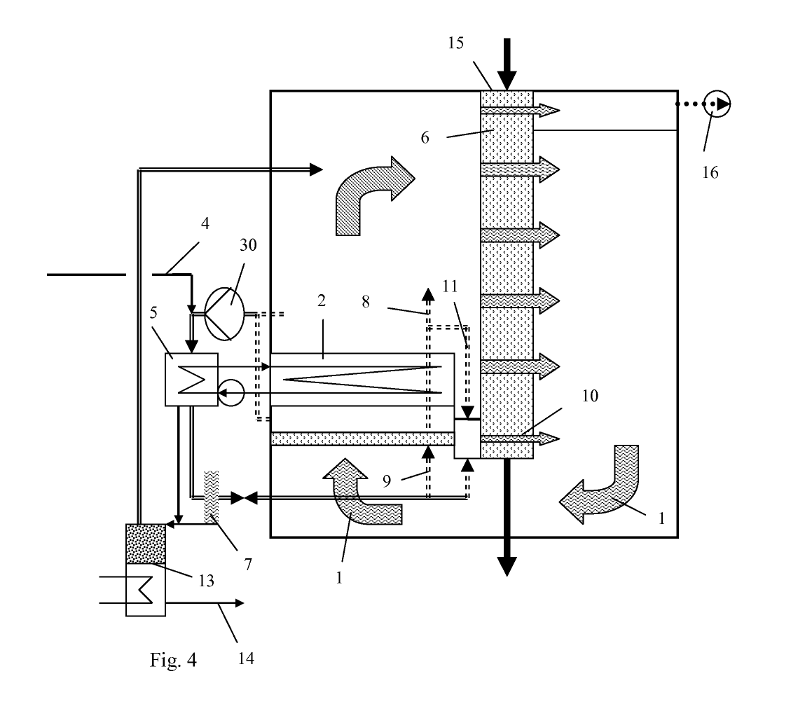

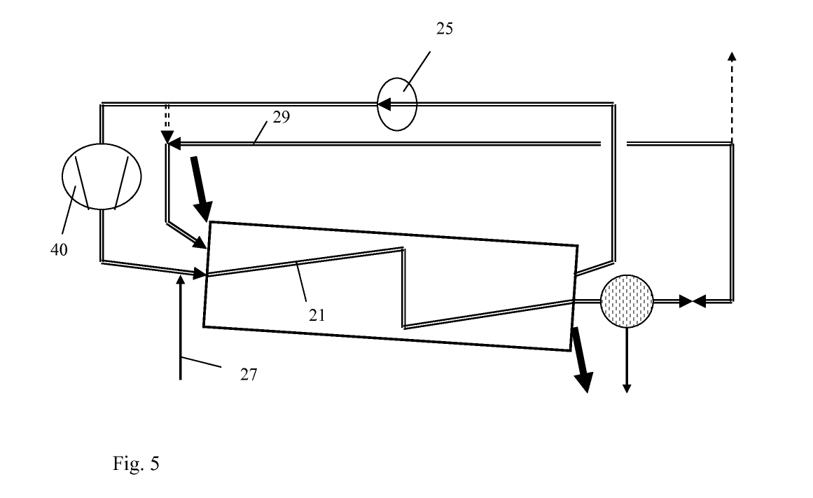

Still another embodiment is shown in FIGS. 4 and 5, wherein the system has been supplemented with a compressor 30 and 40, respectively, which increases the pressure of the gas taking part in the absorption. Hereby the temperature achieved at the absorption is increased, which among other things reduces the need of heat transfer surface, which gives increased capacity in a given apparatus. It can be appropriate to relieve the gas of dust and other disturbing substances upstream of the compressor. This can be done by filtering, washing, or with the aid of a separating heat exchanger. If the absorption solution is added under high pressure an ejector using the energy of the liquid can replace or supplement the compressor. The purified solution can be concentrated further by multiple effect evaporation, and be used in other processes, such as generation of steam, production of electricity, etc.

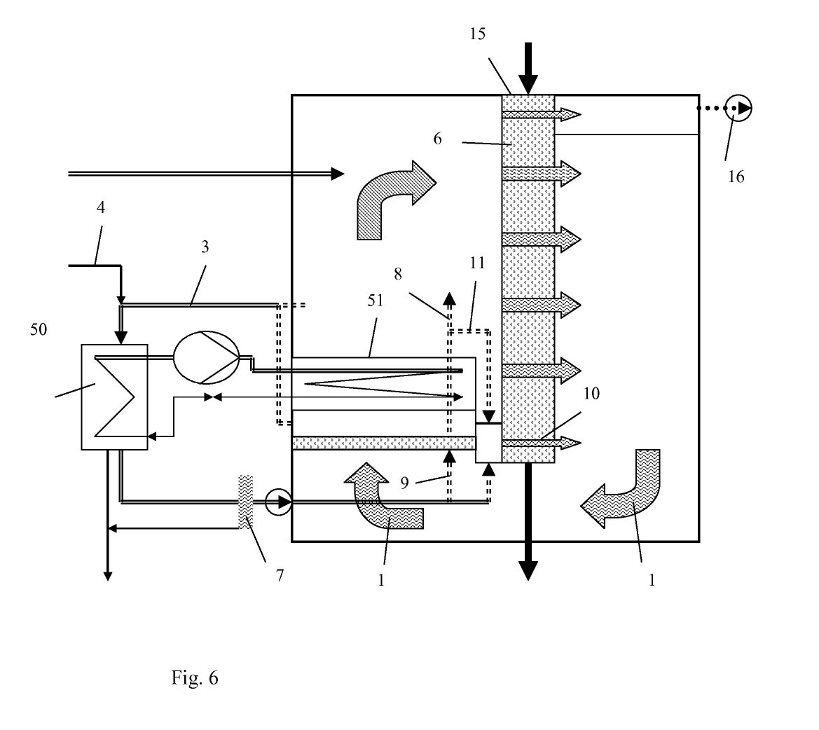

The need of purifying the gas before the compressor and the desire to reduce the size and power demand of the compressor can be met if the absorption step takes place in a heat exchanger in the same way as is shown in FIGS. 2 and 3, but where the heat carrier between the two heat exchangers 50, 51 are comprised of a working medium in a mechanical heat pump, so that the medium is evaporated in the heat exchanger 50 which delivers steam to the compressor 52. After compression the steam is condensed in a conventional heat exchanger 51 which heats drying gas or drying goods. This principle is illustrated in FIG. 6.

The mechanical heat pump is a known technique which is combined with the novel absorption technique. The chemical heat pump compensates for the inability of the mechanical heat pump to treat large contaminated gas volumes of low pressure while at the same time the mechanical heat pump compensates the inability of the chemical heat pump of making large temperature rises. A limited addition of mechanical energy via the compressor also decreases the demand of adding steam in order to maintain the temperature in the process. Of course the two solutions can be combined so that a preheating takes place in a step (chemical or mechanical heat pump) and final heating takes place with heat, the temperature of which has been lifted in both steps. The compressor can be operated with low rpm, low pressure set up and low energy consumption so that mainly the chemical heat pump works. In order to increase the capacity of the plant, the capacity of the compressor is increased so that the drying temperature increases. This gives great possibilities to let the production follow the prevailing cost for electric power by variation of the capacity of the compressor.

### 2. Solar Collector

The solar collectors are illustrated as planar solar collectors, toady being regarded as the most cost effective type, but also other kind of solar collectors are comprised, e.g. vacuum isolated glass tubes, solar collectors with reflectors, etc.

Accordingly, the invention relates to a method with which energy in incident solar radiation is used directly for concentration by evaporation of a liquid and for simultaneous production of heat and possibly also electricity. The liquid is in the first place intended to contain a substance with low volatility but with a strong affinity to a volatile component, whereby the volatile component acts as solvent. The invention will be described for the case where the solvent is water and the non-volatile component is hygroscopic. Examples of non-volatile components are mineral salts with good solubility in water, an organic strongly polar liquid, such as for example a glycol or an alcohol, a soluble organic salt such as sodium or potassium formate or acetate. The liquid can also be comprised of mixtures of several such compounds. Said organic compounds have indeed often a certain vapour pressure, but this is substantially lower than the pressure of the volatile component.

The strong affinity to water leads to that the vapour pressure for water is lowered in contact with the substance compared to contact with pure water at the same temperature, while at the same time the boiling point for the liquid rises.

Another substance combination is ammonia—water, where ammonia is the volatile solvent and water is the substance with strong affinity for the solvent.

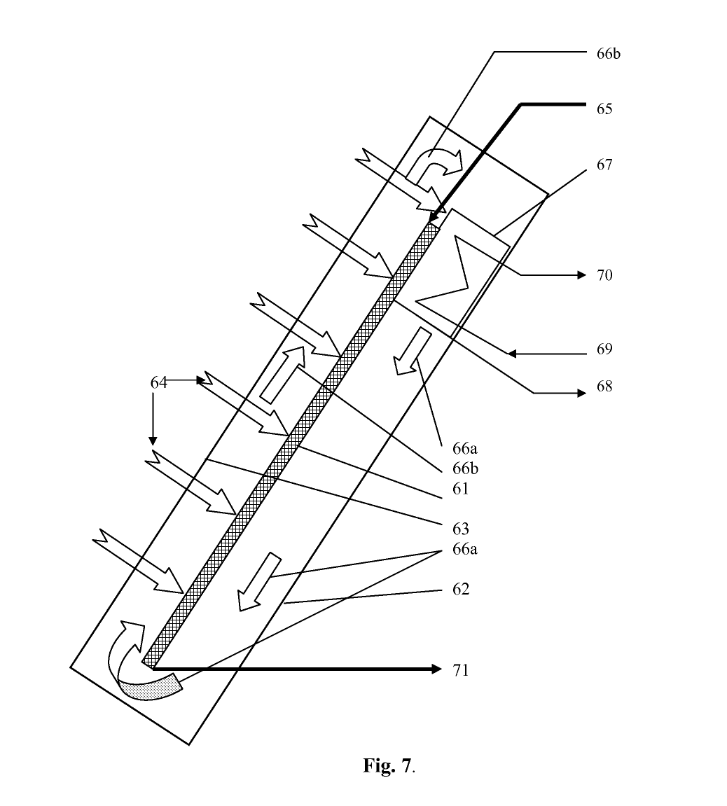

In FIG. 7 is shown a first embodiment of a solar collector for performing the method according to the invention. The device will be described schematically with the parts being essential for the invention, but leaving out pipes, pumps and such means as well as control means. The device comprises an absorber 61 for solar radiation, placed in a containment 62, which prevents direct exchange with the atmosphere, with a cover layer 63, preferably made of glass, which allow solar radiation, indicated with arrows 64, to pass on to the absorber 61, but prevents return radiation of heat. The remaining sides of containment are isolated walls. Further, the device comprises means for distribution of a diluted liquid from a tank not shown in the Fig. over a surface within the confinement, preferably over the absorber 61, which is indicated with the arrow 65. With this, heat absorbed by the absorber is transferred to the diluted liquid so that the volatile component is evaporated. A permanent gas, indicated with arrows 66a, transports heat and volatile component 66b from the absorber, which acts as evaporator, to a heat exchanger 67, which cools the gas, so that latent and sensible heat are extracted, while simultaneously a condensate 68 of the volatile substance is formed. The arrows 66b indicates cooled gas. The permanent gas can be circulated in the system or alternatively it can be exhausted and substituted with new gas, especially in the case where air is the permanent gas.

By cooling the gas in the heat exchanger 67, latent heat and sensible heat is extracted simultaneously with the volatile component condensing to condensate 68. At 69 cold heat carrier is led into the cooler/heat exchanger 67 and at 70 warm heat carrier is drawn off. At the lower end of the absorber concentrated solution is drawn off, indicated with the arrow 71. By condensation in the heat exchanger 67, continued evaporation is facilitated at moderate temperature in the absorber 61. The gas circulates preferably through natural convection, but it is also possible to use a blower.

In a conventional solar collector the heat is captured from the solar radiation as sensible heat on the absorber. This leads to a temperature increase which strongly affects the heat losses. According to the invention a large part of the energy is taken up as latent energy at evaporation of the solvent, which leads to that the temperature inside the glass can be kept lower, which in turn leads to reduced heat losses through the cover layer/glass. Again it should be noted that the invention is described for planar solar collectors but also other types can be used.

Unlike previously known solar collectors this solar collector produces several utilities, in the form of: concentration of a hygroscopic solution (when the solvent is water); production of a flow of pure volatile component; and production of heat which is transferred to a secondary medium in the heat exchanger. All of these utilities can be stored e.g. in tanks and be used upon need. The system can of course also be used for non-hygroscopic liquids, e.g. for treatment of a liquid flow by solar illumination and distillation. In order to achieve a certain dwell time in the evaporator this can be designed so that a larger liquid volume always is exposed for the sunlight.

The heat produced gets a temperature level and a method of use similar to the situation at conventional thermal solar collectors. The concentrated solution can be used in different kinds of absorption processes, e.g. for treatment of a gas (e.g. ventilation air) by dehumidification, re-humidification, heating, cooling. In dehumidification of the air in a building or in the surroundings a surplus of solvent (water) is formed, which can be a valuable resource for other purposes. The solution can also be used in refrigerating machines or heat pumps of absorption type, wherein the solution is the working medium at the production of heat or cold and wherein the solar collector is the regenerator part of the complete absorption process. A further field of application is to use the solution for defrosting of heat absorbing surfaces in heat exchangers, heat pumps, other cooling and refrigerating applications and as an extension of this using a cold solution as a freeze protected, heat absorbing surface in cold environments. Solar collectors according to the invention can be the core in a energy and conditioning system for a unit, such as a building, a vehicle, or the like.

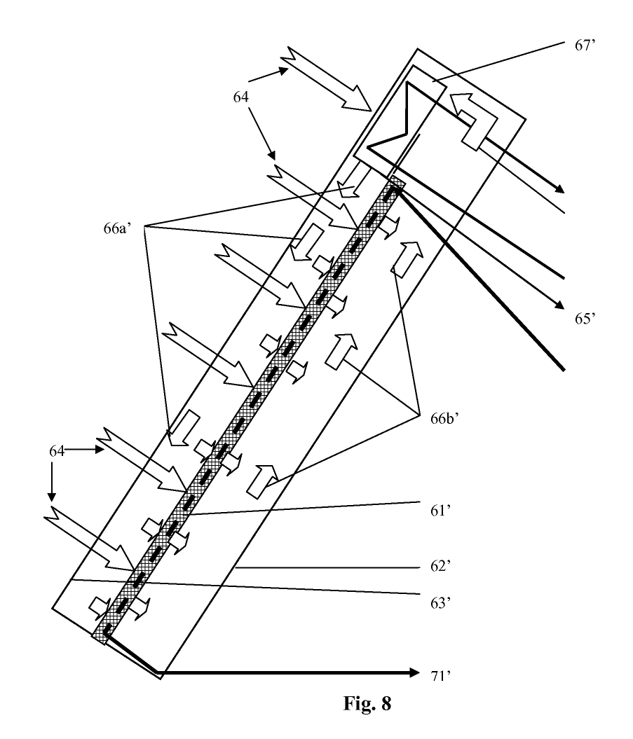

In FIG. 8 is shown a second embodiment of a solar collector according to the invention. The same reference signs marked with “′” are used in this Fig. to indicate similar or corresponding components or flows as in FIG. 7. The device according to FIG. 8 reflects that the factor influencing the efficiency the most in a solar collector is the temperature difference over the cover glass. The other surfaces towards the surroundings can be effectively isolated but the possibilities to isolate the glass surface are very restricted, since the light radiation has to pass. If the internally circulating gas after cooling is led to the space between the glass and the absorber, the temperature difference is reduced so that the losses decrease and the efficiency increases. Unlike the embodiment according to FIG. 7 the cooler 67′ is placed so that the cooled gas flows down on the front side of the absorber 61′. The absorber 61′ extends substantially over the whole extension of the containment 62′ and is permeable so that the gas passes through the absorber. The gas is heated at the passage through the absorber and takes up the volatile component which is evaporated by the heat having been taken up by the absorber and the heated gas 66b′ with volatile component is led through the channel formed between the wall of the containment and the absorber, to the heat exchanger 67′. Thanks to that the cooled gas stays in contact with the cover glass and the heated gas is in contact with the preferably well isolated walls of the containment, a substantial enhancement of the efficiency is obtained. The diluted solution is added to the absorber and is distributed and led through it, whereupon the concentrated solution is drawn off at 71′.

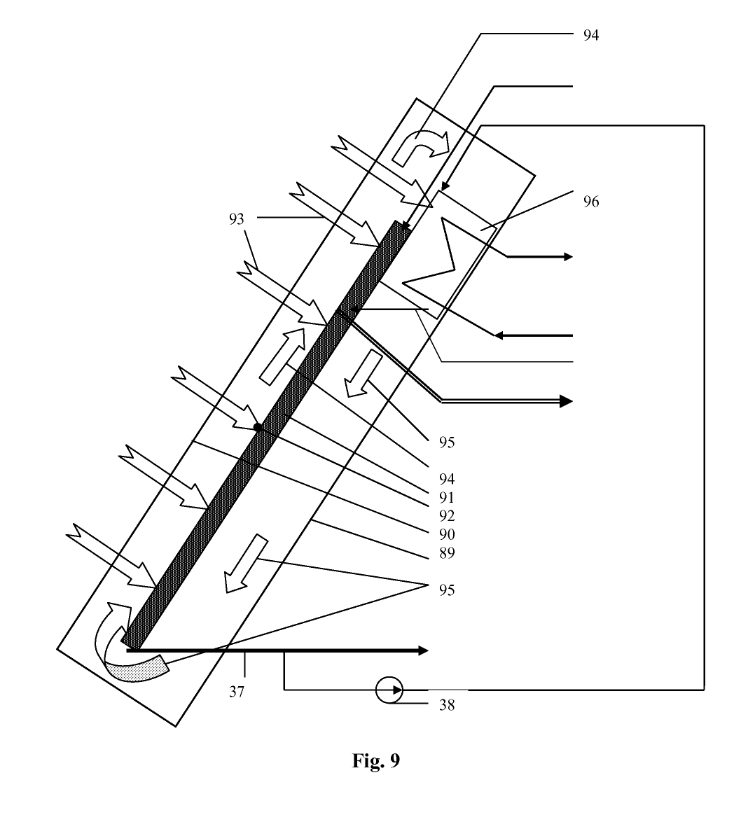

In FIG. 9 is shown a third kind of a device for performing the method according to the invention. The solar collector has in this case a built-in heat pump, is designed for concentration of a solution, production of a distillate, production of electricity and production of heat with raised temperature. In the containment 89 with light permeable restriction wall 90 is shown an absorber 91 in the form of a photovoltaic solar cell panel/evaporator, which generates electricity. Diluted solution from a stock is distributed over the surface of the panel and volatile component is evaporated, at 92, by the heat that is generated by incident sun beams 93. A permanent gas circulates in the same way as in the embodiment according to FIG. 6, heated gas being indicated with arrows 94 and cooled gas with arrows 95. The gas is heated and captures volatile component and is then led through a heat exchanger 96. Concentrated solution 97 from storage or as is illustrated in FIG. 9 from the lower part of the evaporator is pumped with a pump 98 up to and is distributed over the heat absorbing surface of the heat exchanger (=gas cooler). The volatile component is then absorbed to a higher degree and/or at a higher temperature compared to the case without solution containing substances with high affinity for the volatile component. With this procedure the heat carrier leaving the heat exchanger can reach a higher temperature than what prevails in the solar collector. The gas leaving the cooler will contain a smaller share of volatile component, which in turn facilitates the evaporation in the evaporation part. If all of the solution is used in this way the system will become simple in such a way that all solution is circulated alternately over the evaporator and the cooler. Alternatively one can work actively with the storages of solution, heat and distillate.

If the light permeable restriction wall in FIGS. 7-9 is a panel of solar cells or comprises solar cells, which absorb the most energy rich parts of the light spectrum for production of electricity while the rest of the light passes to the thermal absorber, electricity can be produced at the same time as a large part of the heat generation in the solar cells and the energy in the rest of the light are added to the thermal part, as has been described with reference to FIGS. 7-9.

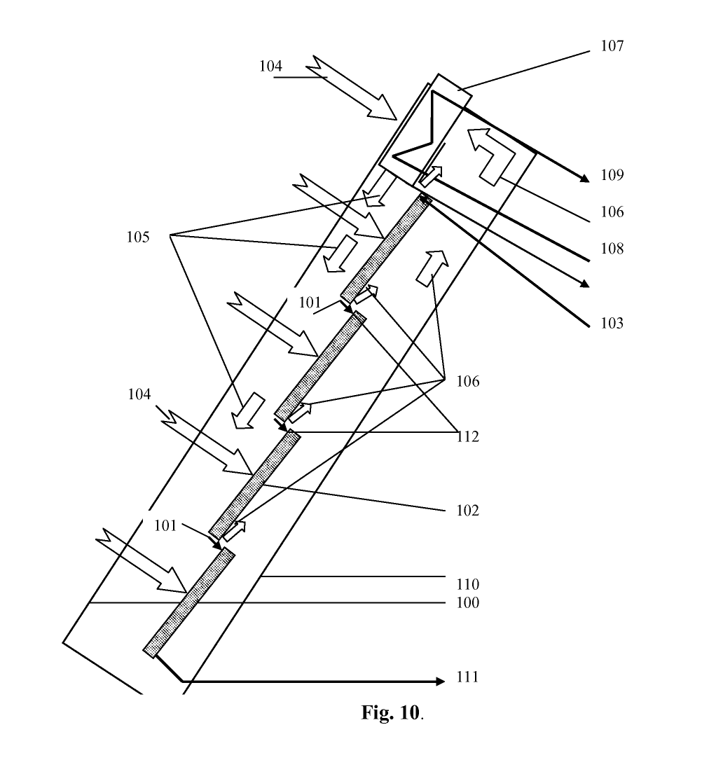

In FIG. 10 is shown a solar collector according to the invention in the form of an embodiment of the solar collector shown in FIG. 8. Similar to the solar collector in FIG. 7 it has a cooled cover panel 100, and is intended for concentration of hygroscopic solution and production of heat and distillate, but unlike the solar collector according to FIG. 8, which has a homogenously permeable absorber, run-through openings 101 are arranged to be distributed along the extension of the absorber 102 and at the same time the absorber consists of solar cell panels from production of electricity. Diluted solution 103 is led into the evaporator/absorber 102, whereby the volatile component is evaporated by heat from the absorber, which is supplied with energy from the incident sunbeams 104. Cold dry gas 105 passes the run-through openings 101 while at the same time it is warmed up and takes up volatile component. The warm gas 46 with volatile component is fed to the cooler 107, in which cold heat carrier 108, e.g. from a tank, is fed and warm heat carrier 109 is drawn off e.g. to a tank. From the lower part of the containment 110 a concentrated solution 111 is drawn off. The incoming diluted solution 103 flows over the absorber, which is indicated at 112.

When solar energy is used for production of electricity in solar cells between 5 and 20% of the incident energy is utilized. One part leaves the system as reflexion but the main part is transformed into heat in the solar cell panel. A solar cell panel can therefore be regarded as a thermal absorber with a somewhat reduced heating effect. If the aim is production of electricity one or several panels of solar cells are used as absorber in the solar collector according to the invention.

In order to relieve the solar cells from influence from the solution the evaporator/evaporation can be moved from the absorber/solar cell panel to the back of the solar collector.

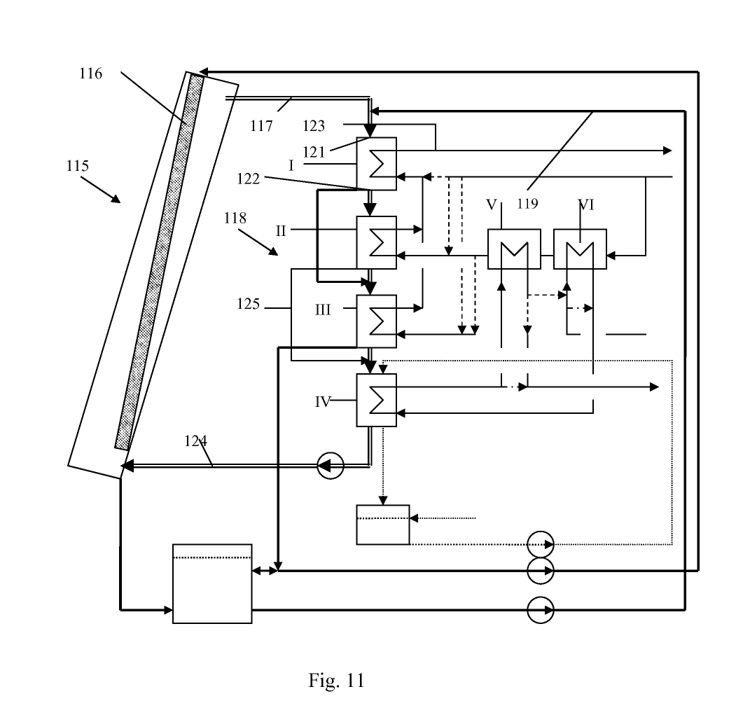

A further application of the invention is schematically illustrated in FIG. 11. Here, in the same way as before, a diluted solution is concentrated in a solar collector 115 with an absorber 116 for solar energy in some of the previously described embodiments. The solvent evaporated from the solution, arrow 117, is fed with the aid of a permanent gas to a system 118 of heat exchangers, which extract heat while the gas at the same time is dehumidified. The heat exchanger system 118 can be integrated in the solar collector or placed in the vicinity in order to serve several solar collectors. For clarity reasons the heat exchanger system is shown schematically outside the solar collector 115. The humid and warm gas (e.g. air with a high content of solvent, such as water) is cooled and dehumidified in several steps I, II and III to be humidified again thereafter in a heat demanding step IV, which accordingly produces cold.

In the schemtically shown flow chart the gas heated in the solar collector passes four heat exchanging steps I-IV.

I—The gas is contacted with concentrated solution, arrow 119, which gives a temperature rise at absorption/condensing of the solvent in the solution. The process is performed in the heat exchanger I, wherein the heating surface is covered by the solution. Gas and liquid are fed in parallel flow through the heat exchanger, which gives a big temperature rise in the inlet 121 and a low content of solvent in the gas at the outlet 122. Thereafter the gas is moderately dehumidified and still warm. The heated medium, arrow 123, is fed in counter flow in view of the gas and can because of an increase in boiling temperature reach a temperature which exceeds the temperature of the incoming gas.

II—In heat exchanger II cooling takes place without solution, which results in condensation of pure solvent because cooling takes place down a to sufficiently low temperature. The gas will be slightly more dry and cold.

III—In heat exchanger III cooling with solution occurs, which gives further absorption of solvent at similar temperatures as in the preceding step. The gas thereby becomes very dry, which also means that the energy condition of the gas, the enthalpy, is low.

IV—Addition of pure solvent, from II, a tank or external addition, results in evaporation in the dry gas, which cools the gas down towards the saturation temperature at the prevailing energy content of the gas while at the same time heat is taken up for the continued evaporation. In the heat exchanger heat is added at low temperature. The absorbed amount of heat can be used for cooling purposes. The gas becomes almost saturated and approaches the temperature of the heating medium, the energy content in the gas is now again relatively high but the temperature is low.

The gas is then fed back, arrow 124, to the solar collector 115 wherein the solar energy heats the gas, so that it can evaporate solvent from the warm solution that flows over or through the absorber. Since the gas before contact with the absorber is cold, the heat loss from the absorber becomes less than if the gas was warm. It should be noted that the absorber acts as absorber for solar energy and at the same time as desorber for solvent. In the solar collector the gas is heated and humidified to a high energy condition with moderate temperature and is then fed to the heat exchanger I according to the above.

With the aid of the above described system the following is achieved: Heat is produced in the same way as before with high efficiency in the solar collector and to a higher temperature of the heat carrier compared to what prevails in the solar absorber. By reducing the flow of circulating gas the temperature and the humidity of the gas in to the heat exchanger I are increased, so that the absorption temperature and thereby the heat carrier temperature increases. Additionally further heat is extracted in connection with further dehumidification in the following heat exchangers II-III. This heat can be of more restricted use since its temperature is lower. The cooling of the gas, I-III, is critical for the production of cold in the last step. In the second heat exchanger II the gas is cooled without solution with the aim of producing a pure condensate for use in the production of cold in the fourth heat exchanger, arrow 125. Heat exchangers I and II can also be connected in parallel in the gas flow so that I produces heat of high temperature and II produces condensate. The distribution of the gas can be controlled so that a desired amount of condensate is produced.

In order to obtain highest possible dehumidification of the gas solution and cooling is combined in the third heat exchanger III. If the incoming heating medium temperature does not give the desired cooling in the heat exchangers II and III, internally generated cold from the heat exchanger IV can be used in order to achieve the desired temperature e.g. in heat exchanger V and VI for liquid. By controlling this heat transfer, the cooling temperature in step IV can be controlled. The liquid flows can thereby be connected and controlled in several different ways depending on the circumstances and the prevailing operative situation.

After dehumidification and cooling the gas is contacted with pure solvent in the heat exchanger IV. Part of the solvent is evaporated, whereby gas and liquid is cooled towards the saturation temperature at the prevailing energy condition. During this process the medium is cooled on the other side of the heat exchanger.

The cooling effect that is produced is proportional to the flow of gas that is circulated in the system. In operation the yield of heat with high temperature can be optimized against the yield of cold by controlling the gas flow. A smaller flow gives heat of higher temperature, a higher flow gives increased cooling effect. At the same time the middle cooling should produce a sufficient amount of pure solvent in order to correspond to the cooling demand. When these balances are achieved the production takes place without other external supply than solar energy except for the energy demand for circulation of the medium, etc., a need that can be well met by the solar cells that can be part of the system.

By letting moisture in the gas, that is fed back to the solar collector from the heat exchanger IV condense against the inside of the cover glass heat of low value can be cooled away.

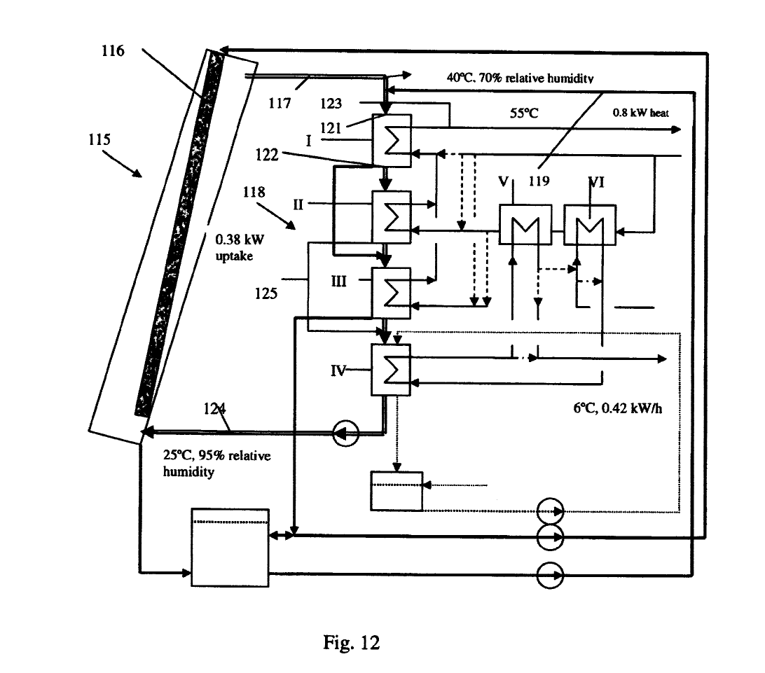

In order to illustrate the capacity of the solar collector according to the invention data for a typical operation situation have been inserted in FIG. 12, which corresponds to FIG. 11. At an insolation of 0.73 kW the loss will be 0.35 kW and 0.38 kW is taken up by the solar collector. The gas leaving the solar collector and being fed into the heat exchanger system has a temperature of 40° C. and a relative humidity of 95%. Heat corresponding to 0.8 kW at a temperature of 55° C. and a cold corresponding to 0.42 kW at a temperature of 6° C. are produced by the system.

The system according to the invention thereby is a solar driven heat pump using a cooling demand or other optional heat source of low temperature for producing heat of a higher temperature.

According to a development of the invention the optional heat source of the above described system is a collector wherein heat losses from the solar collector are collected and are added as low-tempered heat in the system, whereby a very good efficiency can be combined with a high delivery temperature. The gathering of heat losses can take place by placing a heat exchanger over the solar collector so that heated air from the area in front of the cover glass of the solar collector is contacted with the heat exchanger. Also the special case that one uses the space between double cover layers on the solar collector, e.g. a glass and a film, is comprised by the invention.

1. A method for extraction of solvent and heat from a gas by absorbing solvent in a solution containing solvent and one or several absorbents with strong affinity to the solvent, characterized in that absorption is effected by bringing gas and solution into contact in parallel flow mainly on one side of a heat exchanger, wherein the heat liberated during the absorption is simultaneously transferred indirectly or regeneratively to a cooling medium, which meets the absorption media in counter flow.

2. The method according to claim 1, characterized in that the system is closed to the environment and permanent gases are evacuated for the formation of a sub-pressure at the absorption while at the same time heat is produced at a temperature level exceeding the saturation temperature of the solvent.

3. The method according to claim 1, characterized in that the system is closed in relation to the environment except for a smaller flow, which is drawn into the system and is evacuated to prevent emissions and to take care of or render harmless gaseous components from the drying goods, which are not absorbed by the absorption solution.

4. The method according to claim 1 for drying of drying goods, characterized in that a gas is circulated between one unit where it is contacted with drying goods and a unit for removal of solvent taken up from the drying goods and reheating of the gas, in that a partial flow of the circulating gas is contacted with absorption solution in parallel flow in a heat exchanger, and in that the resulting heat is utilized for drying of the drying goods.

5. The method according to claim 4, characterized in that the drying goods is heated to a desired temperature by addition of solvent in vapor form.

6. The method according to claim 4, characterized in that the drying goods is cooled to a desired temperature by cooling the absorption with an external cooling agent, which can be stored for future use or be utilized for other purposes.

7. The method according to claim 5, characterized in that said solvent in vapor form is contacted in counter flow with used absorption solution so that the content of volatile compounds of the solution is returned to the main process.

8. The method according to claim 5, characterized in that the solvent vapor is comprised of a flow which has been evaporated from the absorption solution.

9. The method according to claim 4, characterized in that the gas after passage of the drying goods is heated in a first heat exchanger, that a partial flow of the gas is taken out of the gas flow before or after said heating and is contacted with absorption solution in parallel flow in a second heat exchanger and in that the resulting heat is utilized in the first heat exchanger for heating of the gas.

10. The method according to claim 9, characterized in that the two heat exchangers constitute a unit without intermediate heat carrier.

11. The method according to claim 9, characterized in that a heat carrier in the form of a working medium for a mechanical heat pump is circulated between the two heat exchangers, whereby said heat carrier is evaporated in the heat exchanger in which said partial flow is brought into contact with absorption solution in parallel flow, that formed vapor is distributed to and compressed in a compressor, from where the vapor is fed to and condensed in the heat exchanger, which heats drying gas or drying goods.

12. The method according to claim 4, characterized in that the circulating gas after passage of the drying goods is returned to the drying goods and that a partial flow is contacted with absorption solution in parallel flow in a heat exchanger enclosed by drying goods, whereby the absorption is conducted on one side of the heat exchanger heating surface and heat is transferred directly to the drying goods on the other side.

13. The method according to claim 12, characterized in that the pressure on said partial flow is increased before it is contacted with the absorption solution.

14. The method according to claim 12, characterized in that the partial flow before absorption/heat exchange is purified from dust with a method known per se.

15. The method according to claim 12, characterized in that the partial flow is purified in view of residues of the absorption solution.

16. The method according to claim 12, characterized in that the partial flow after absorption/heat exchange is fed directly back to the drying process.

17. The method according to claim 12, characterized in that all or parts of the partial flow is drawn off from the system after absorption and heat exchange together with gaseous compounds from the drying goods, which are enriched in the circulating gas.

18. The method according to claim 12, characterized in that said partial flow constitute between 5 and 50% of the circulating gas.

19. The method according to claim 4, characterized in that the solvent to be dried off is water and in that the solvent is hygroscopic.

20. The method according to claim 4, characterized in that the absorbent is adjusted by additives so that substances being released during the drying are captured by the absorbent.

21. The method according to claim 4, characterized in that when drying of drying goods emitting organic acids, such as wood, a corresponding organic salt is used as absorbent, whereby the pH value is controlled by addition of alkaline compounds, e.g. K₂CO₃ or alkaline ashes.

22. The method according to claim 4, characterized in that when drying of drying goods emitting alkaline substances acid compounds are used as additives to the absorption solution.

23. The method according to claim 22, characterized in that when the emitted substance is ammonia a weak acidic solution, e.g. ammonium nitrate, is used as absorbent with addition of L 0 nitric acid for controlling the pH value.

24. The method according to claim 4, characterized in that the absorption solution is utilized alternately for drying of a material that emits acids, e.g. wood, and for drying of a gas from combustion of a fuel containing alkaline compounds, e.g. wood.

25. The method according to claim 20, characterized in that solid substance formed in the absorption solution is separated according to any known method.

26. The method according to claim 20, characterized in that any surplus of absorption solution is separated from the system together with impurities in the solution.

27. The method according to claim 1 for direct utilisation of solar energy for production of heat, cold, electricity and/or distillate by evaporation of a solvent from a liquid, capturing av solar energy with an absorber for solar energy arranged in a containment with a light permeable limiting wall, addition of a dilute solution of a solvent and a substance with strong affinity for said solvent to the absorber, whereby the captured solar energy is substantially transformed to latent heat in evaporated solvent, feeding of a permanent gas in the containment adjacent to the absorber for absorbing evaporated solvent and heat, and transfer of the latent and sensible energy in a heat exchanger arranged inside or outside the containment for giving off heat to a heat carrier circulating through the heat exchanger and condensation of solvent, characterized in that the capture is performed in a container with heat insulated walls, that the gas circulating in the solar collector after passage of the solar energy absorber is contacted in parallel flow with concentrated solution in the absorber/heat exchanger and is heat exchanged therein in counter flow with the heat carrier.

28. The method according to claim 27, characterized in that the diluted solution is added to the absorbing surface of the solar energy absorber and that the permanent gas is circulated over the energy absorbing surface of the solar energy absorber, thereafter through the heat exchanger and then past the solar energy absorber on the side facing away from the energy absorbing surface back to the solar energy absorbing surface.

29. The method according to claim 27, characterized in that the solar energy absorber is gas permeable and that the gas is circulated through the solar energy absorber from the solar energy absorbing side to the opposite side, thereafter through the absorber/heat exchanger and thereafter again being fed through the solar energy absorber from its solar energy absorbing side.

30. The method according to claim 29, characterized in that the solar energy absorber is permeable to the gas.

31. The method according to claim 29, characterized in that the solar energy absorber presents a number of discrete passing-through openings for the gas.

32. The method according to claim 27, characterized in that the solar energy absorber comprises solar cells for simultaneous generation of electricity.

33. The method according to claim 27, characterized in that the light permeable limitation wall comprises partially light-permeable solar cells, preferably with such properties that the high frequent spectrum of the light is absorbed and the rest of the light passes.

34. The method according to claim 27, characterized in that the solution is alternately fed over the solar energy absorber working as evaporator and through the absorber/heat exchanger acting as absorber for solvent and cooler, whereby a heat pump function is achieved.

35. The method according to claim 27, characterized in that water is used as solvent and a hygroscopic substance is used as non-volatile component, e.g. mineral salts with high solubility in water, an organic strongly polar liquid, such as for example a mono or multivalent alcohol, a soluble semi-organic salt such as sodium formate, potassium formate, sodium acetate or potassium acetate.

36. The method according to claim 27, characterized in that the permanent gas is air.

37. The method according to claim 27, characterized in that the circulating gas is contacted in parallel flow with concentrated solution in several steps (I; III) in heat exchangers that are cooled by a heat carrier meeting said gas and solution in counter flow, whereby is achieved a far reaching de-humidification of the gas.

38. The method according to claim 37, characterized in that the gas thereafter is humidified in a heat demanding step (IV) in order to produce cold to a refrigeration system, whereby is achieved a heat pump function when the heat taken up from the refrigeration system reaches the heat carrier.
